(19) United States
(12) Patent Application Publication
(10) Pub. No.: US 2010/0142381 A1
(43) Pub. Date: Jun. 10, 2010

(54) MECHANISMS FOR FAILURE DETECTION AND MITIGATION IN A GATEWAY DEVICE

(75) Inventors: Keith R. Broerman, Carmel, IN (US); Barry J. Weber, Carmel, IN (US); Aaron M. Smith, Noblesville, IN (US)

Correspondence Address: Robert D. Shedd, Patent Operations;THOMSON Licensing LLC, P.O. Box 5312, Princeton, NJ, 08543-5312, US

(73) Assignee: Thomson Licensing, LLC, Boulogune-Billancourt (FR)

(21) Appl. No.: 12/596,696

(22) PCT Filed: Dec. 19, 2007
(86) PCT No.: PCT/US07/25946

§ 371 Date: Feb. 19, 2010

Related U.S. Application Data
(60) Provisional application No. 60/925,792, filed on Apr. 23, 2007.

(51) Int. Cl. H04L 12/26

(52) U.S. Cl. 370/242

(57) ABSTRACT

A system and method of the present disclosure provides a block, or region, based error diffusion process for reducing artifacts in images. The system and method allows for the generation and the control of the spatial frequency of a masking signal, e.g., noise, in a way that it can be easily passed through the compression process. The system and method provides for selecting a block size of pixels of the image, adding a masking signal to the image, determining a quantization error for at least one block in the image, and distributing the quantization error to neighboring blocks in the image to mask artifacts in the image. An output image is then encoded with a compression function.

### CROSS REFERENCE TO RELATED APPLICATION

This application claims the benefit under 35 U.S.C. §119 of a provisional application 60/925,792 filed in the United States on Apr. 23, 2007.

### BACKGROUND OF THE INVENTION

1. Field of the Invention

The present embodiments generally relate to gateway devices that may be used to provide services for multi-dwelling units (MDUs), and more particularly, to mechanisms for detecting and mitigating failure conditions associated with such gateway devices.

2. Background Information

Systems for providing services such as satellite television service have been deployed that utilize a structure that is complementary to the needs of multi-user operation in a single location such as multiple dwelling buildings or apartments. The arrangement of the system used for an installation such as an MDU installation often includes client devices connected through a local network to a central device, or gateway device, that is connected to the service provider's network. Failures within a given gateway device due to hardware or software may occur and result in degradation of system performance and service calls from users.

One approach to detecting and mitigating software module failures within a given gateway device involves the use of watchdog monitors. Such watchdog monitors may be, for example, set on a per-thread basis to monitor one or more threads of execution and to indicate thread failure (i.e., micro-level failure detection). In many cases, more complex software modules are comprised of multiple threads of execution as well as third-party object modules that are not monitored, and that may also use the services of a transmission control protocol/internet protocol (TCP/IP) stack. In these more complex modules, the per-thread watchdog monitor approach may not be sufficient to detect a failure of the overall software module or loss of software function point(s).

Accordingly, there is a need for improved mechanisms for detecting and mitigating failure conditions associated with gateway devices. The present embodiments described herein address this and/or other issues and provides a macro-level capability to detect hardware and software module failures across one or more gateway devices.

### SUMMARY OF THE INVENTION

In accordance with an aspect of the present disclosure, a method for detecting a failure in a gateway device is disclosed. According to an exemplary embodiment, the method includes the steps of: receiving a first announcement regarding service associated with operation of a network, determining a classification of the first announcement, initializing a timing interval based on the classification of the first announcement, and providing an error message if a second announcement of a same classification as the first announcement is not received before the timing interval expires.

In accordance with another aspect of the present disclosure, a gateway device is disclosed. According to an exemplary embodiment, the gateway device includes a network interface for receiving a first announcement regarding service associated with operation of the network, and a processor for determining a classification of the first announcement, initializing a timing interval based on the classification of the first announcement, and providing an error message if a second announcement of a same classification as the first announcement is not received before the timing interval expires.

In accordance with another aspect of the present disclosure, a further device is disclosed. According to an exemplary embodiment, the device includes means for receiving a first network announcement regarding service associated with operation of the network, and means for determining a source of the first network announcement and a type of the first network announcement, initializing a timing interval, and providing an error message if a second announcement from the source of the first network announcement and of the same type as the first network announcement is not received before the timing interval expires.

### BRIEF DESCRIPTION OF THE DRAWINGS

The above-mentioned and other features and advantages of this present embodiments, and the manner of attaining them, will become more apparent and the disclosure will be better understood by reference to the following description of embodiments taken in conjunction with the accompanying drawings, wherein:

FIG. 1 is a block diagram illustrating an exemplary system using embodiments of the present disclosure;

FIG. 2 is a block diagram illustrating a relevant portion of one of the gateway devices of FIG. 1;

FIG. 3 is a block diagram illustrating an exemplary embodiment of one of the gateway devices of FIG. 1; and

FIG. 4 represents a portion of a flow chart illustrating an exemplary method using embodiments of the present disclosure.

FIG. 5 represents another portion of a flow chart illustrating an exemplary method using embodiments of the present disclosure.

FIG. 6 represents another portion of a flow chart illustrating an exemplary method using embodiments of the present disclosure.

The exemplifications set out herein illustrate preferred embodiments of the disclosure, and such exemplifications are not to be construed as limiting the scope of the embodiments in any manner.

### DESCRIPTION OF THE PREFERRED EMBODIMENTS

The embodiments described above are primarily directed towards installation systems found in multiple dwelling units. The embodiments may also be used and applied in any network information distribution system utilizing a head-end or gateway interface providing content over a data network to client devices, settop boxes, or receiving circuits. For example, the embodiments described may be modified using techniques known to one skilled in the art to work in an airplane or motorbus passenger entertainment distribution system.

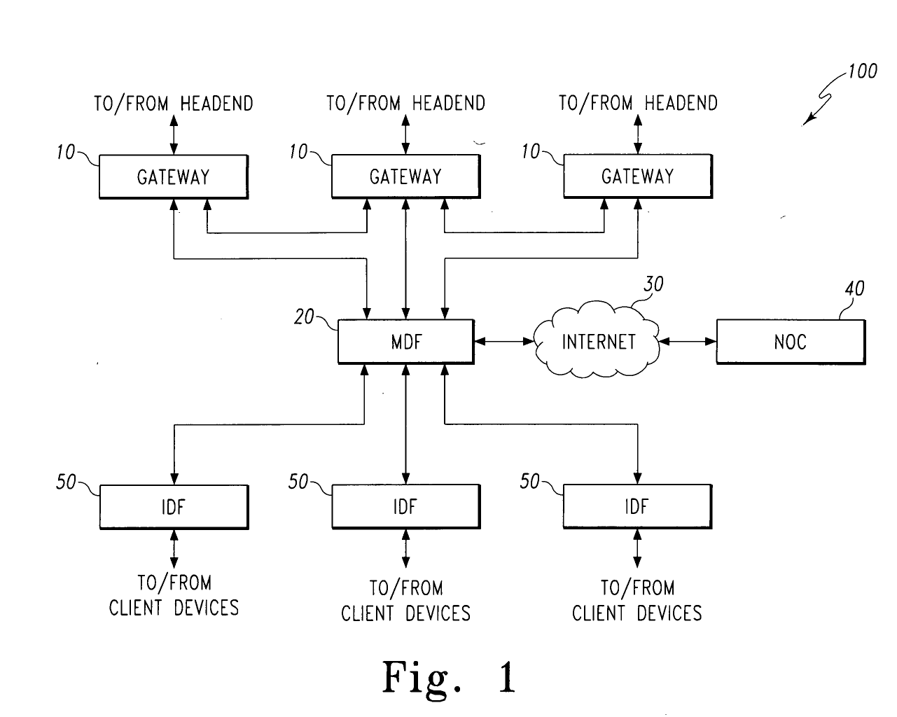

Referring now to the drawings, and more particularly to FIG. 1, an exemplary system 100 using embodiments of the present disclosure is shown. As indicated in FIG. 1, exemplary system 100 comprises one or more system to headends (not shown), gateway devices 10, a main distribution frame (MDF) 20, a network such as internet 30, a network operating center (NOC) 40, intermediate distribution frames (IDFs) 50, and client devices (not shown). According to an exemplary embodiment, FIG. 1 represents a typical system that may be employed in an MDU using an Ethernet network or other type of network, such as coaxial cable, digital subscriber line (DSL), powerline networking, or wireless technologies.

In FIG. 1, each gateway device 10 is operatively coupled to and communicates with a system headend (i.e., service provider), such as the headend of a satellite, terrestrial, cable, internet and/or other type of broadcast system. According to an exemplary embodiment, each gateway device 10 receives multiple signals including audio and/or video content from the system headend(s), converts the signal format of the received signals and then sends appropriate data streams in a format, such as the internet protocol (IP) format, through the network via MDF 20 and IDFs 50 to the client devices (e.g., set-top boxes, televisions, etc.) based on requests made by users in the respective dwelling units. As is known in the art, MDF 20 and IDFs 50 operate as switching and routing devices. The number of gateway devices 10, MDFs 20 and IDFs 50 included in a given MDU installation may vary based on design choice. Each IDF 50 may for example service client devices present on a given floor and/or other defined portion of an MDU. Although system 100 is shown and described herein as being an Ethernet switched network using a specific network format, those skilled in the art will appreciate that the principles of the present disclosure may also be applied to other types of networks such as networks using coaxial cable, digital subscriber line (DSL), powerline networking, and/or wireless technologies, and a number of possible network formats.

It is important to note that more than one gateway device 10 may be connected to the same system service provider head-end. Multiple gateway devices 10 may be needed in order to receive and distribute all of the available content from the service provider due to design constraints of the size or capability of a single gateway device 10. Further, the gateway devices 10 may include the ability to connect and communicate between each other independent of, or in conjunction with, the local network connection made to MDFs 20.

As indicated in FIG. 1, MDF 20 is operatively coupled to and communicates with NOC 40 via internet 30 or other suitable network connection. According to an exemplary embodiment, MDF 20 is operative to receive notification messages related to the operational status of gateway devices 10, and transmit such notification messages to NOC 40. In the event that one of these notification messages indicates an operational problem (e.g., hardware and/or software module failure, etc.) with one of the gateway devices 10, appropriate action (e.g., service call, new software download, re-boot failed gateway device without operator intervention, etc.) may be taken to identify and resolve the problem. According to principles of the present disclosure, each gateway device 10 is operative to detect operational problems present with itself and/or other gateway devices 10 and to provide such notification messages to NOC 40 via MDF 20 and internet 30. In this manner, the present disclosure is advantageously able to detect and mitigate failure conditions in a gateway device 10 used for example in an MDU network.

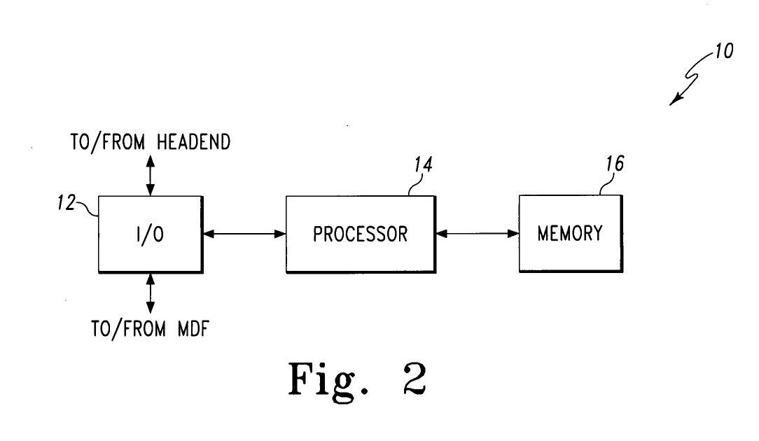

Referring to FIG. 2, a block diagram illustrating a relevant portion of one of the gateway devices 10 of FIG. 1 is shown. Gateway device 10 of FIG. 2 includes an I/O block 12, processor 14, and memory 16. For clarity of description, certain conventional elements associated with gateway device 10 such as certain control signals, power signals and/or other elements may not be shown in FIG. 2.

I/O block 12 is operative to perform I/O functions of gateway device 10. According to an exemplary embodiment, I/O block 12 is operative to receive signals such as audio, video and/or data signals in analog and/or digital format from one or more headend signal sources such as satellite, terrestrial, cable, Internet and/or other signal sources. I/O block 12 is also operative to output signals to the one or more headend signal sources. I/O block 12 is also operative to transmit and receive signals to and from MDF 20. In an exemplary embodiment I/O block 12 includes a signal interface for receiving broadcast signals contain audio and video content and a network interface for transmitting and receiving signals in the form of data signals on a local network including MDF 20. The data signals may include signals representing audio and video content processed by the gateway devices 10 and network announcements generated by gateway devices 10.

Processor 14 is operative to perform various signal processing and control functions of gateway device 10. According to an exemplary embodiment, processor 14 is operative to process the audio, video and/or data signals received by I/O block 12 so as to place those signals in a format that is suitable for transmission to and processing by the client devices.

Processor 14 is also operative to execute software code that enables the detection and mitigation of operational problems (e.g., hardware and/or software module failure, etc.) associated with one or more gateway devices 10 (including itself) according to principles of the present disclosure. In a preferred embodiment, processor 14 is a microprocessor operative to execute software code that determines a classification of an announcement after receiving information regarding the announcement. Processor 14 further executes code that initializes a timing interval based on the classification of the announcement, and provides an error message if information regarding a second announcement of a same classification as the earlier received announcement is not received before the timing interval expires. Further details regarding this aspect of processor 14 will be provided later herein. Processor 14 is also operative to perform and/or enable other functions of gateway device 10 including, but not limited to, processing user inputs made via a user input device (not shown), generating outputs including notification messages, reading and writing data from and to memory 16, and/or other operations.

Memory 16 is coupled to processor 14 and performs data storage functions of gateway device 10. According to an exemplary embodiment, memory 16 stores data including, but not limited to, software code, one or more data tables, pre-defined notification messages, user setup data, and/or other data.

The gateway devices 10 may be configured to receive a number of different types of broadcast signals including a plurality of satellite signals. Gateway devices 10 may also be configured to produce a plurality of network data signals containing audio and video content provided in the broadcast signals, and to provide the network data signals over the network connecting the gateway devices 10 to client devices.

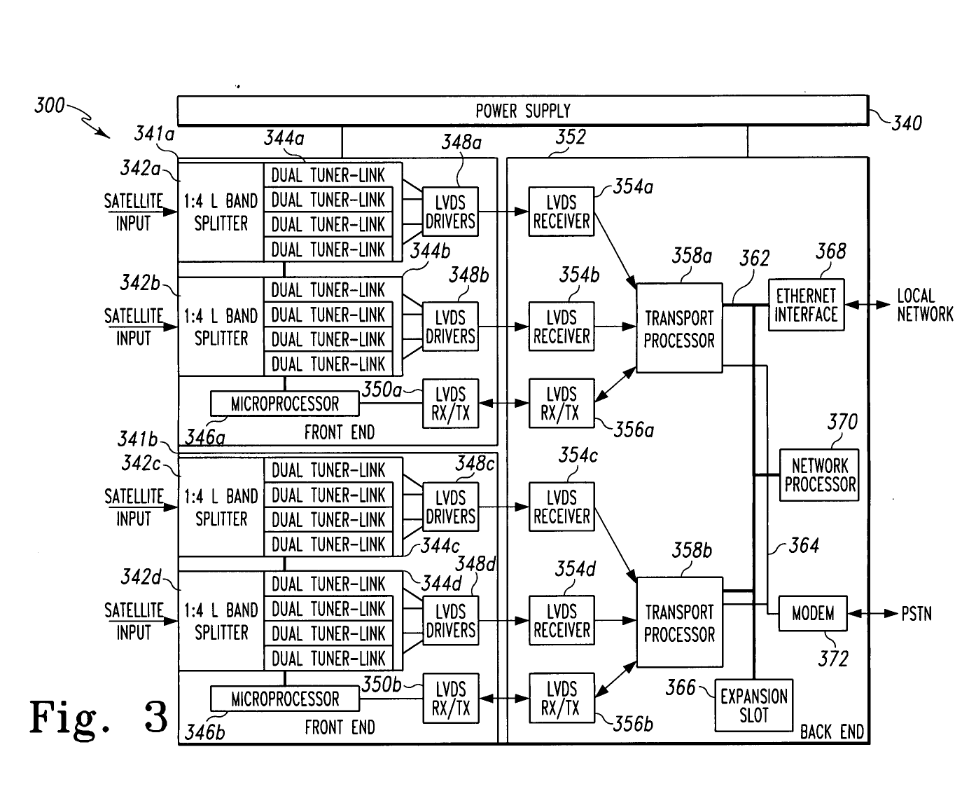

Referring now to FIG. 3, a block diagram of an exemplary satellite gateway device 300 is shown. Satellite gateway device 300 is similar to gateway device 10 as described in FIG. 1. As illustrated, the satellite gateway device 300 includes a power supply 340, two front-ends 341a and 341b and a back-end 352. The power supply 340 may be any one of a number of industry-standard AC or DC power supplies configurable to enable the front-ends 341a, b and the back-end 352 to perform the functions described below.

The satellite gateway device 300 may also include two front-ends 341a, b. In one embodiment, each of the front-ends 341a, b may be configured to receive two signals provided from the 1:2 splitters 326a-26d. For example, the front-end 341a may receive two signals from the 1:2 splitter 326a and the front-end 341b may receive two signals from the 1:2 splitter 326b.

The front-ends 341a, b may then further sub-divide the signals using 1:4 splitters 342a, 342b, 342c, and 342d. Once subdivided, the signals may pass into four banks 344a, 344b, 344c, and 344d of dual tuner links. Each of the dual tuner links within the banks 344a-344d may be configured to tune to two services within the signals received by that individual dual tuner link to produce one or more transport streams. Each of the dual tuner links 344a, 344,b, 344c, and 344d transmits the transport streams to one of the low-voltage differential signaling (“LVDS”) drivers 348a, 348b, 348c, and 348d. The LVDS drivers 348a-348d may be configured to amplify the transport signals for transmission to the back-end 352. In alternate embodiments, different forms of differential drivers and/or amplifiers may be employed in place of the LVDS drivers 348a-348d. Other embodiments may employ serialization of all of the transport signals together for routing to the back end 352.

As illustrated, the front-ends 341a, b may also include microprocessors 46a and 46b. In one embodiment, the microprocessors 346a, b control and/or relay commands to the banks 344a-344d of dual tuner links and the 1:4 splitters 342a-342d. The microprocessors 346a, b may comprise, for instance, ST10 microprocessors produced by ST Microelectronics. In other embodiments, a different processor may be used or the control may be derived from processors in the back end 352. The microprocessors 346a, b may be coupled to LVDS receiver and transmitter modules 350a and 350b. The LVDS receiver/transmitter modules 350a, b facilitate communications between the microprocessors 346a, b and components on the back-end 352, as will be described further below.

Turning next to the back-end 352, the back-end 352 includes LVDS receivers 354a, 354b, 354c, and 354d which are configured to receive transport stream signals transmitted by the LVDS drivers 348a-348d. The back-end 352 also includes LVDS receiver/transmitter modules 356a and 356b which are configured to communicate with the LVDS receiver/transmitter modules 350a, b.

As illustrated, the LVDS receivers 354a-354d and the LVDS receiver/transmitters 356a, b are configured to communicate with controllers or transport processors 358a and 358b. In one embodiment, the transport processors 358a, b are configured to receive the transport streams produced by the dual tuner links in the front-ends 341a, b. The transport processors 358a, b may also be configured to repacketize the transport streams into Internet protocol (IP) packets which can be multicast over the local network described earlier. For example, the transport processors 358a, b may repackage broadcast protocol packets into IP protocol packets and then multicast these IP packets on an IP address to one or more of the client devices

The transport processors 358a, b may also be coupled to a bus 362, such as a 32 bit, 66 MHz peripheral component interconnect (“PCI”) bus. Through the bus 362, the transport processors 358a, b may communicate with another controller or network processor 370, an Ethernet interface 384, and/or an expansion slot 366. The network processor 370 may be configured to receive requests for services from the local network and to direct the transport processors 358a, b to multicast the requested services. Additionally, the network processor 370 may also manage the operations and distribution of data signals containing audio and video content by receiving the requests from the client devices, maintaining a list of currently deployed services, and matching or allocating the receiving resources for providing these services to the STBs 22a-22n. The network processor may also be manage network status through the receiving, monitoring, and/or processing of network related announcements provided the gateway devices 10. In one embodiment, the network processor is an IXP425 produced by Intel and executes software code that determines a classification of a network announcement after receiving information regarding the announcement. Processor 14 further executes code that initializes a timing interval based on the classification of the announcement, and provides an error message if information regarding a second network announcement of a same classification as the earlier received announcement is not received before the timing interval expires. While not illustrated, the network processor 370 may also be configured to transmit status data to a front panel of the satellite gateway device 300 or to support debugging or monitoring of the satellite gateway device 300 through debug ports.

As illustrated, the transport processors 358a, b are coupled to the Ethernet interface 368 via the bus 362. In one embodiment, the Ethernet interface 368 is a gigabit Ethernet interface that provides either a copper wire or fiber-optic interface to the local network. In other embodiments, other interfaces such as those used in digital home network applications may be used. In addition, the bus 362 may also be coupled to an expansion slot, such as a PCI expansion slot to enable the upgrade or expansion of the satellite gateway device 300.

The transport processors 358a, b may also be coupled to a host bus 64. In one embodiment, the host bus 364 is a 16-bit data bus that connects the transport processors 358a, b to a modem 372, which may be configured to communicate over the public service telephone network (PSTN) 28. In alternate embodiments, the modem 372 may also be coupled to the bus 362.

The network processor 370 may also contain a memory for storing information regarding various aspects of the operation of the satellite gateway device 300. The memory may reside within the network processor 370 or may be located externally, although not shown. The memory may be used to store status information, such as information about timers and network announcements, as well as tuning information for the receiving resources.

It is important to note that transport processors 358a,b, network processor 370, and microprocessors 346a, b may be included in one larger controller or processing unit capable of performing any or all of the control functions necessary for operation of the satellite gateway device 300. Some or all of the control functions may also be distributed to other blocks and not affect the primary operation within satellite gateway device 300.

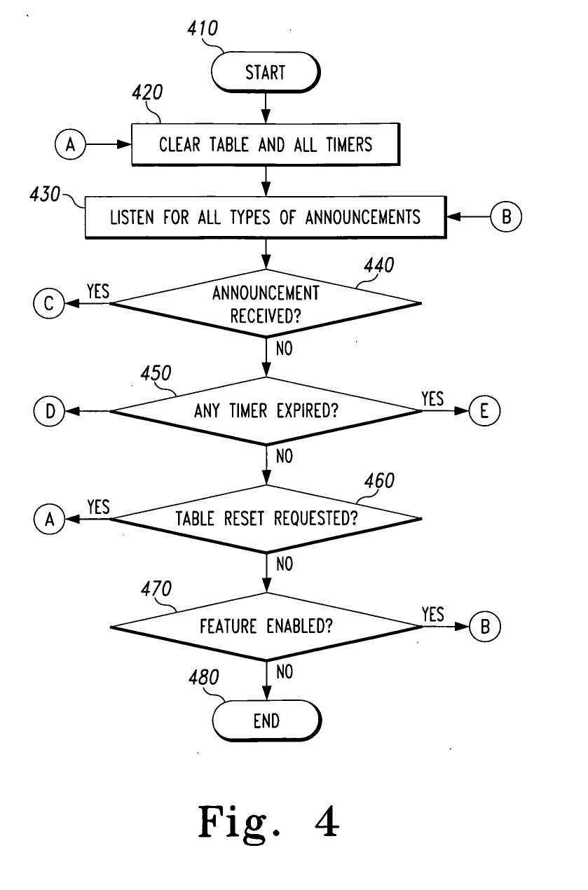

Referring to FIGS. 4 to 6, a flowchart illustrating an exemplary method using embodiments of the present disclosure is shown. For purposes of example and explanation, the method of FIGS. 4 to 6 will be described with reference to system 100 of FIG. 1 and the elements of gateway device 10 of FIG. 2. The method of FIGS. 4 to 6 may equally be described with reference to the elements of satellite gateway 20 of FIG. 1. Also for purposes of example and explanation, the steps of FIGS. 4 to 6 will be primarily described with reference to only one gateway device 10. In practice, however, it is anticipated that each gateway device 10 in a given MDU installation will to separately and independently perform the steps of FIGS. 4 to 6. The steps of FIGS. 4 to 6 are exemplary only, and are not intended to limit the present embodiments in any manner.

At step 410, the method starts. According to an exemplary embodiment, the method starts at step 410 only if the feature for detecting and mitigating operational problems (e.g., hardware and/or software module failure, etc.) associated with one or more gateway devices 10 is enabled. For purposes of example explanation, it is assumed that this feature is initially enabled.

At step 420, gateway device 10 clears a table and all timers. According to an exemplary embodiment, each gateway device 10 stores a table in memory 16 that is used for the detection and mitigation of operational problems (e.g., hardware and/or software module failure, etc.) associated with one or more gateway devices 10 (including itself). According to this exemplary embodiment, each gateway device 10 periodically transmits and re-transmits announcements according to a pre-defined protocol, such as the Session Announcement Protocol (SAP) which carries the Session Description Protocol (SDP). Both the SAP and SDP are known in the art. There are various types or classifications of announcements including announcements related to network availability, proxy modem host availability, client device software availability, or other types of application-related matters. For each unique SAP packet SDP payload received by gateway device 10, the aforementioned table in memory 16 stores: (i) the IP address of the sending gateway device 10 (i.e., a gateway device 10 identifier), (ii) the type or classification of SAP announcement, (iii) the media title (which corresponds to item (ii)), and (iv) the time of packet arrival. For each gateway device 10 and type or classification of announcement, processor 14 maintains a corresponding timer. At step 420, processor 14 clears the aforementioned table in memory 16 and all of its corresponding internal timers that are used for the detection and mitigation of operational problems. These internal timers are part of a failure detection module of processor 14.

At step 430, gateway device 10 listens for all types of announcements. According to an exemplary embodiment, gateway device 10 monitors SAP announcements issued by itself, as well as by any or all other active gateway devices 10, under the control of processor 14 at step 430. Gateway device 10 may for example monitor a particular IP address under the control of processor 14 in order to listen for the announcements at step 430.

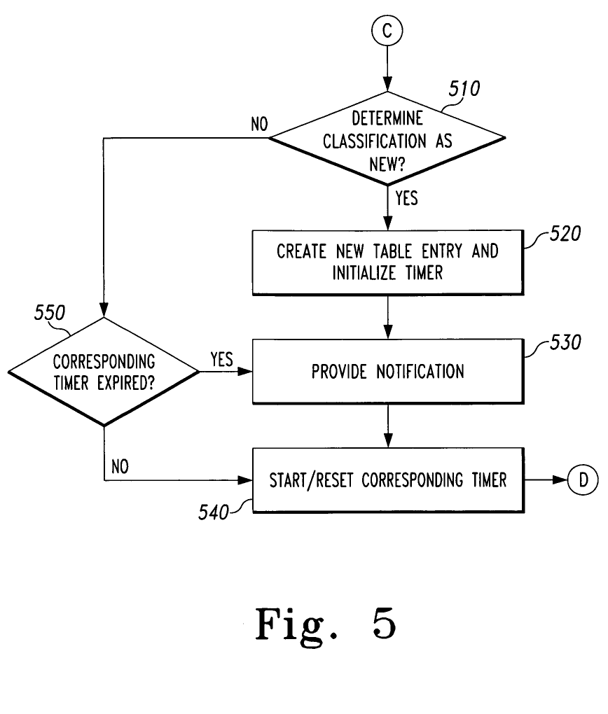

At step 440, a determination is made as to whether an announcement is received by gateway device 10. According to an exemplary embodiment, processor 14 detects whether an announcement is received from another gateway device 10 or itself, to thereby make the determination at step 440. If the determination at step 440 is positive, process flow advances to “C” (see FIG. 5), as will be described later herein. Alternatively, if the determination at step 440 is negative, process flow advances to step 450 where a determination is made as to whether any timer is expired. According to an exemplary embodiment, processor 14 checks its internal timers (i.e., the ones cleared at step 420) to make the determination at step 450. As indicated in FIG. 4, process flow also advances to step 450 from “D” (see FIG. 5), as will be described later herein.

It is important to note that a number of methods of maintaining or monitoring a time interval may be possible in place of using an internal timer in processor 14. For example, the timer may be an external clock circuit connected to a crystal, a sampling circuit that samples an existing continuous time signal, or a software algorithm that runs on processor 14.

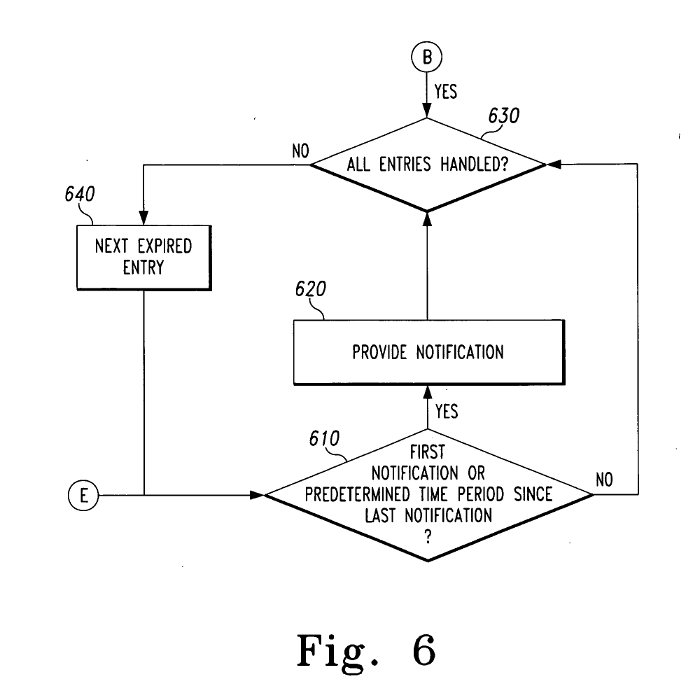

If the determination at step 450 is positive, process flow advances to “E” (see FIG. 6), as will be described later herein. Alternatively, if the determination at step 450 is negative, process flow advances to step 460 where a determination is made as to whether a table reset is requested. According to an exemplary embodiment, the table in memory 16 referred to in step 420 may be manually reset from time to time by a network administrator or other authorized individual, and/or may be automatically reset based on a user setting. Accordingly, processor 14 makes the determination at step 460 by detecting whether this table needs to be reset.

If the determination at step 460 is positive, process flow loops back to step 420 as indicated by “A”. Alternatively, if the determination at step 460 is negative, process flow advances to step 470 where a determination is made as to whether the feature for detecting and mitigating operational problems (e.g., hardware and/or software module failure, etc.) associated with one or more gateway devices 10 (including itself) is enabled. According to an exemplary embodiment, this feature of the present disclosure may be manually turned on (i.e., enabled) and off (i.e., disabled) by a network administrator or other authorized individual. Accordingly, processor 14 makes the determination at step 470 by detecting whether this feature is enabled. If the determination at step 470 is positive, process flow loops back to step 430 as indicated by “B”. Alternatively, if the determination at step 470 is negative, process flow advances to step 480 where the method ends.

Referring now to FIG. 5, “C” (i.e., a positive determination at step 440 of FIG. 4) advances to step 510 where a determination is made as to whether the announcement received at step 440 represents a new type or classification of announcement from a particular gateway device 10. According to an exemplary embodiment, processor 14 makes the determination at step 510 by examining entries of the aforementioned table in memory 16. As previously indicated above, announcements related to network availability, proxy modem host availability, client device software availability, or other types of application-related matters may represent different types or classifications of announcements.

If the determination at step 510 is positive, process flow advances to step 520 where gateway device 10 creates a new table entry and initializes a corresponding timer for the particular gateway device 10 and type or classification of announcement. According to an exemplary embodiment, processor 14 performs step 520 by creating a new table entry in memory 16 and initializing a corresponding timer internally. From step 520, process flow advances to step 530 where gateway device 10 sends a notification message under the control of processor 14 to NOC 40 (via MDF 20 and internet 30) to indicate that a new table entry has been created and that a corresponding timer has been initialized.

Referring back to step 510, if the determination there is negative, process flow advances to step 550 where a determination is made as to whether a corresponding timer is expired. According to an exemplary embodiment, processor 14 makes the determination at step 550 by detecting whether its internal timer corresponding to the particular gateway device 10 and type or classification of announcement received at step 440 is expired.

If the determination at step 550 is positive, process flow advances to step 530 where gateway device 10 sends an error notification message under the control of processor 14 to NOC 40 (via MDF 20 and internet 30) to indicate that a timer corresponding to the particular gateway device 10 and type or classification of announcement has expired. In other words, if the determination at step 550 is positive, the error notification message sent at step 530 also indicates that gateway device 10 has not received a second or subsequent announcement of the same type or classification as a previously received announcement from a particular gateway device 10 before the corresponding timer expired. Accordingly, this error notification message notifies NOC 40 of a potential operational problem associated with the applicable gateway device 10, and allows for corrective action to be taken.

From step 530 or if the determination at step 550 is negative, process flow advances to step 540 where gateway device 10 starts or resets the corresponding timer. According to an exemplary embodiment, processor 14 performs step 540 by starting or resetting the corresponding timer. From step 540, process flow loops back to step 450 (see FIG. 4) as represented by “D”.

Referring now to FIG. 6, “E” (i.e., a positive determination at step 450 of FIG. 4) advances to step 610 where a determination is made as to whether the last notification message was the first notification message sent for a to particular gateway device 10 and type or classification of announcement, or whether a time period, such as 10 minutes, has passed since the last notification message was sent for the particular gateway device 10 and type or classification of announcement. According to an exemplary embodiment, processor 14 makes the determination at step 610 using internally maintained timing information.

It is important to note that each type or classification of announcement may use a different time period, further enhancing the operation of the present disclosure. For example, a network availability announcement typically has a repetition time period of approximately two seconds while a network time announcement has a repetition time period of approximately twelve hours.

If the determination at step 610 is positive, process flow advances to step 620 where gateway device 10 sends a notification message under the control of processor 14 to NOC 40 (via MDF 20 and internet 30) to indicate the condition determined at step 610. From step 620 or if the determination at step 610 is negative, process flow advances to step 630 where a determination is made as to whether all expired table entries in memory 16 have been handled. According to an exemplary embodiment, processor 14 makes the determination at step 630 using internally maintained status information.

If the determination at step 630 is positive, process flow loops back to step 430 (see FIG. 4), as indicated by “B”. Alternatively, if the determination at step 630 is negative, process flow advances to step 640 where the next expired table entry is handled. From step 640, process flow loops back to step 610.

As described above, the flowchart of FIGS. 4 to 6 provides mechanisms for detecting and mitigating failure conditions associated with gateway devices 10. In summary, each active gateway device 10 periodically re-transmits its announcements. A failure detection module of processor 14 includes a set of timers, namely one timer for each combination of gateway device 10 and unique announcement type/media title (e.g., [GW1 id, announcement type 1], [GW1 id, announcement type 2] . . . [GW3 id, announcement type 1], [GW3 id, announcement type 2] . . . ). According to principles of the present embodiments, when a new announcement type/media title is received from a particular gateway device 10, an entry corresponding to the particular gateway device 10 and announcement type/media title is placed in the table in memory 16 and a timer for the entry is started. If the timer expires before another announcement of that type/media title is received from the particular gateway device 10, action is taken (e.g., notification message is sent to NOC 40, initiate a service call, new software download, re-boot failed gateway device without operator intervention, etc.) to indicate/resolve the problem. The notification messages may include service information including the IP address of the failed gateway device 10 as well as the failed service. Once a timer expires, the system notification may be periodically resent until the announcement from the particular gateway device 10 is again received or the failure detection module is reset or administratively disabled.

The failure of a gateway device 10 to receive another gateway device's 10 announcement(s) can indicate a failure of the sending gateway device's 10 hardware (e.g., power supply, network interface, etc.) or a failure of one or more of its software modules responsible for the service that it provides. The failure of a gateway device 10 to receive its own announcement(s) can indicate a failure of one or more of its software modules responsible for the service that it provides. In an installation of three or more gateway devices 10, the system notification messages are redundant, thereby enhancing the reliability of such notifications. For example, two operational gateway devices 10 can detect a loss of one of more announcements from a failed third gateway device 10, and each gateway device 10 will send a notification message indicating this fact to NOC 40.

It is also important to note that the present embodiments primarily cover failure detection for gateway devices 10, but may also be used in conjunction with failure mitigation. Further, the disclosed embodiments describe using SAP announcements in detection and mitigation schemes.

SAP announcements are user datagram packets (UDP) containing a SAP (Request for Comment (RFC) 2974) payload, itself containing a SDP (RFC 2327) payload, and transmitted by each active gateway device 10 on a well-known multicast IP address. Each class of SAP announcement advertises a service offering and provides details on its capabilities and how to access the service. For example, current SAP announcements include network availability, proxy modem host availability, client device software availability, and network time.

The embodiments of the present disclosure describe provide several advantages with respect to operation of a system requiring a monitoring process for hardware or software failures during operation. These advantages include, but are not limited to, a self monitoring capability which may give a network monitor more information about the state of the system and use of standard IP messages, such as SAP announcements, to not only convey the system status such that anyone on the network can tell the activity status and indicate whether or not a network device is functional, but also to convey other important messages and information. Further, the use of such messages may allow polling by a remote system monitor or may allow information about the failure to be pre-emptively sent. Also, the various interval timeout values for the interval timers maintained by processor 14 may be remotely settable and the announcement types may be remotely configurable. Once notification messages are generated, the messages could be sent to multiple operator-specified NOC destinations.

As described herein, the embodiments of the present disclosure relate to a failure monitoring technique has been developed so that hardware and software failures in a multiple gateway system may be detected and reported. In a single gateway system, the approach supports failure detection of key software modules. The embodiments of the present disclosure address, among other things, various classes of problems in a multiple gateway device installation, including the fact that gateway devices 10 with non-redundant power supplies can't detect their own power supply failure, and gateway devices 10 can't report their own failures if their communication interface hardware has failed. Further, embodiments of the present disclosure may also addresses the class of problems in a single or multiple gateway installation related to detecting catastrophic software module failures using a simple watchdog monitor-based approach, when multiple threads, third-party object code, etc. is involved. Also, although the initial implementation only broadcasts the SAP announcements either between gateway devices 10 or on the local network, extensions of this implementation, even utilizing other types of network announcements, could be developed such that these announcement could be sent to NOC 40.

While this disclosure has been described as having a preferred design, the present embodiments can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which the embodiments pertain and which fall within the limits of the appended claims.

1. A method for detecting a failure in a gateway device, comprising the steps of:
receiving a first announcement regarding service associated with operation of a network;
determining a classification of the first announcement;
initializing a timing interval based on the classification of the first announcement; and
providing an error message if a second announcement of the classification of the first announcement is not received before the timing interval expires.

2. The method of claim 1, wherein the first announcement includes at least one of a network availability announcement, a proxy modem host availability announcement, and a client device software availability announcement.

3. The method of claim 1, wherein the first announcement uses a session announcement protocol.

4. The method of claim 1, wherein the gateway device is operating properly if the second announcement of the same classification as the first announcement is received before the timing interval expires.

5. The method of claim 1, wherein the classification includes a source device identification for the first announcement.

6. The method of claim 1, further comprising the step of
storing information including the determined classification and the timing interval associated with the determined classification.

7. A device, comprising:
A network interface for connecting to a data network operative to receive a first announcement regarding service associated with operation of the data network; and
a processor connected to the network interface operative to determine a classification of the first announcement, initialize a timing interval based on the classification of the first announcement, and provide an error message if a second announcement of a same classification as the first announcement is not received before the timing interval expires.

8. The device of claim 7, wherein the first announcement includes at least one of a network availability announcement, a proxy modem host availability announcement, and a client device software availability announcement.

9. The device of claim 7, wherein the first announcement uses a session announcement protocol.

10. The device of claim 7, wherein the device is operating properly if the second announcement of the same classification as the first announcement is received before the timing interval expires.

11. The device of claim 7, wherein the classification includes a source device identification for the first announcement.

12. The device of claim 7, wherein the device further includes a signal interface connected to the processor operative to receive signals containing audio and video content provided over a broadcast network.

13. The device of claim 7, wherein the device is one a plurality of gateway devices connected to the data network.

14. The device of claim 7, further comprising
a memory for storing information including the classification and the timing interval associated with the classification.

15. A device, comprising:
means for receiving a first network announcement regarding service associated with operation of a network; and
means for determining a source of the first network announcement and a type of the first network announcement, initializing a timing interval, and providing an error message if a second announcement from the source of the first network announce and of a same type as the first announcement is not received before the timing interval expires.

16. The device of claim 15, wherein the first announcement includes at least one of a network availability announcement, a proxy modem host availability announcement, and a client device software availability announcement.

17. The device of claim 15, wherein the first announcement uses a session announcement protocol.

18. The device of claim 15, wherein the device further includes:
means for receiving a plurality of signals over a broadcast network comprising audio and video content; and
means for transmitting the audio and video content using the network.
